(19) United States
(12) Patent Application Publication
(10) Pub. No.: US 2008/0273097 A1
(43) Pub. Date: Nov. 6, 2008

(54) IMAGE CAPTURING DEVICE, IMAGE CAPTURING METHOD AND CONTROLLING PROGRAM

(75) Inventor: Akio NAGASHIMA, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/057,052

(22) Filed: Mar. 27, 2008

(30) Foreign Application Priority Data
Mar. 27, 2007 (JP) 2007-082091

(51) Int. Cl. H04N 5/76; G06K 9/00

(52) U.S. Cl. 348/231.99; 382/118

(57) ABSTRACT

When a shutter button is half-pressed, image signal of a field image is read from a CCD, and is converted into image data of digital. For example three faces are detected based on the image data, and a face central coordinate of each face is extracted and a face centroid coordinate of the faces is calculated based on the face central coordinates. When all of the face central coordinates are inside the shooting screen and the face centroid coordinates is inside the determination area, the digital camera induces the user to perform image capturing, with use of an LED and audio guidance. When the shutter button is full-pressed, image signal of a frame image is read from a CCD, and is converted into image data of digital. After various image processing, the image data is stored in a memory card.

### BACKGROUND OF THE INVENTION

1. Field of the Invention

The present invention relates to an image capturing device, an image capturing method and a controlling program, and especially relates to an image capturing device, an image capturing method and a controlling program which are suitable for a self-portrait, which is an image of a user taken by himself or herself.

2. Description of the Related Arts

When a user takes a self-portrait, which is an image of a user taken by himself or herself, it is possible that a face of the user runs off a shooting screen. As an image capturing device for preventing this problem, a digital camera of Japanese Patent Laid-Open Publication No. 2005-217768 is known.

In the digital camera of Japanese Patent Laid-Open Publication No. 2005-217768, a face contour of a subject is detected based on image signal output from an imaging element, and whether the face contour is inside the shooting screen or not is judged. A user holds the digital camera with a taking lens facing to the user. When this digital camera judges that a face of the user runs off the shooting screen, one of four LEDs indicating four directions of left, right, up and down illuminates to guide the user where to move the digital camera. The user moves the digital camera till when all of the four LEDs illuminate at the same time, then performs shutter-release operation.

For capturing a self-portrait, usually a self-timer is used. In consideration of this, an image capturing device, in which a liquid crystal display plate can move to face a subject and a self-timer mode is automatically set when shutter-release operation is performed by remote control, is disclosed for example in Japanese Patent Laid-Open Publication No. 2005-134847.

In capturing of a self-portrait, sometimes there becomes a failure that an image of a face whose direction does not correctly facing the image capturing device is captured. In consideration of this problem, an image capturing device, which automatically captures an image when detecting that a subject faces a certain direction, is disclosed for example in Japanese Patent Laid-Open Publication No. 2003-224761. The image capturing device pre-stores an image recognition pattern for faces facing a predetermined direction, and automatically performs image capturing when it is detected that a face of a subject corresponds to the image recognition pattern.

In capturing of a self-portrait, the user usually holds the camera by the left hand (the nondominant hand of most people) for shutter release operation. Accordingly, sometimes the image capturing failures due to camera shake. To prevent this problem, for example Japanese Patent Laid-Open Publication No. 2001-249379 discloses a camera which automatically performs self-timer shooting or remote control shooting when the self-portrait mode is set.

In addition, to prevent the problem that a face of the user runs off a shooting screen, for example Japanese Patent Laid-Open Publication No. 2003-295261 discloses a camera which automatically sets a focal distance of the taking lens (zoom lens) at the wide end when the self-portrait mode is set.

By the way, there are many cases that plural members want to be captured at the same time in the self-portrait mode. Sometimes the users want to perform the image capturing even when it is difficult that face contours of all faces are inside the shooting screen at the same time (a part of the face runs off the shooting screen). However, the image capturing devices of the above-cited references do not consider these cases.

### SUMMARY OF THE INVENTION

An object of the present invention is to provide an image capturing device, an image capturing method and a controlling program which can prevent a bad mistake of image capturing, such as all or a large part of human face is out of the shooting screen even when there are plural subjects.

In order to achieve the above and other objects, an image capturing device of the present invention, which obtains image data by photo-electrically converting a subject image focused on an imaging element through an imaging optical system and stores the image data in a storing section, comprises a face detecting section, a face center detecting section, a face centroid detecting section, a judging section and a controlling section. The face detecting section detects a face of the subject based on the image data. The face center detecting section detects a central coordinate of the face in a shooting screen based on the image data of the detected face. The face centroid detecting section detects a centroid coordinate which is a center of all faces based on the central coordinate of each face detected by the face center detecting section when plural faces are detected by the face detecting section. The judging section judges whether the central coordinate of each face is inside the shooting screen or not and whether the centroid coordinate is inside a predetermined determination area provided in the shooting screen or not. The controlling section permits image capturing when the judging section judges that the central coordinate is inside the shooting screen and the centroid coordinate is inside the determination area.

It is preferable that the image capturing device further comprises an eye detecting section for detecting both eyes of the subject based on the image data of the face detected by the face detecting section and for detecting whether the both eyes are open or not, and the controlling section permits image capturing when the judging section judges that the central coordinate is inside the shooting screen and the centroid coordinate is inside the determination area, and the eye detecting section detects that the both eyes are open.

It is preferable that the determination area is smaller than said shooting screen which is set at the center of said shooting screen and has a shape similar to said shooting screen.

It is preferable that the controlling section informs the subject that the image capturing is permitted, when the controlling section permits the image capturing.

It is preferable that the controlling section gives a guidance to persuading the user to change a position of the subject or the image capturing device so that the image capturing is permitted, when judges that the image capturing cannot be permitted.

It is preferable that the image capturing device further comprises an area size changing section for reducing a size of the determination area with respect to the shooting screen as the number of the detected faces increases.

It is preferable that the controlling section automatically performs the image capturing when permits the image capturing.

It is preferable that the controlling section automatically performs continuous image capturing of plural frames when permits the image capturing.

It is preferable that the imaging optical system is a zoom lens whose focal distance can be changed, and the image capturing device further comprises a face size detecting section, a face size designating section and a face size judging section. The face size detecting section detects a size of the detected face in the shooting screen based on the image data of the face. The face size designating section designates a face size. The face size judging section judges whether the detected face size corresponds with the designated face size or not. Wherein the controlling section changes the focal distance of the imaging optical system when the face size judging section judges that the detected face size does not correspond with the designated face size.

It is preferable that the face size designating section designates the face size according to at least one mode selected from an up-shot mode in which a closeup of the face of the subject is captured, a bust-shot mode in which an upper body of the subject is captured, and a full-shot mode in which a whole body of the subject is captured.

It is preferable that the controlling section performs capturing a bust-shot image, trimming an up-shot image from the bust-shot image and recording the bust-shot image and the up-shot image when the face size designating section designates the up-shot mode and the bust-shot mode at once. It is preferable that the controlling section performs capturing a full-shot image, trimming a bust-shot image from the full-shot image and recording the full-shot image and the bust-shot image when the face size designating section designates the bust-shot mode and the full-shot mode at once. It is preferable that the controlling section performs capturing a full-shot image, trimming an up-shot image from the full-shot image and recording the full-shot image and the up-shot image when the face size designating section designates the up-shot mode and the full-shot mode at once. And it is preferable that the controlling section performs capturing a full-shot image, trimming a bust-shot image and an up-shot image from the full-shot image and recording the full-shot image, the bust-shot image and the up-shot image when the face size designating section designates the up-shot mode, the bust-shot mode and the full-shot mode at once.

An image capturing device of the present invention, which obtains image data by photo-electrically converting a subject image focused on an imaging element through an imaging optical system and stores the image data in a storing section, comprises a segment designating section, a number and interval setting section, a self-timer, a face detecting section, a face center detecting section, a face centroid detecting section, a judging section, an exposure calculating section, a focus position detecting section and a controlling section. The segment designating section virtually divides a shooting screen into plural segments and designates a segment for displaying a face of the subject. The number and interval setting section sets the number of image capturing and a capturing interval. The self-timer starts time measurement in response to shutter release operation and permits image capturing after a predetermined time is passed. The face detecting section detects a face of the subject based on the image data after the self-timer starts time measurement. The face center detecting section detects a central coordinate of the face in a shooting screen based on the image data of the detected face. The face centroid detecting section detects a centroid coordinate which is a center of all faces based on the central coordinate of each face detected by the face center detecting section when plural faces are detected by the face detecting section. The judging section judges whether the central coordinate of each face is inside the designated segment or not and whether the centroid coordinate is inside a predetermined determination area provided in the designated segment or not. The exposure calculating section calculates a correct exposure based on the image data of the face. The focus position detecting section detects a focus position based on the image data of the face. And the controlling section locks the correct exposure and the focus position and performs image capturing with the number of image capturing and the capturing interval set by the number and interval setting section, when the judging section judges that the central coordinate is inside the designated segment and the centroid coordinate is inside the determination area and after the self-timer measures the predetermined time.

It is preferable that the controlling section gives a guidance to persuading the user to change a position of the subject or the image capturing device, when the judging section judges that the central coordinate is not inside the designated segment and/or the centroid coordinate is not inside the determination area.

An image capturing method of the present invention, which is for obtaining image data by photo-electrically converting a subject image focused through an imaging optical system and storing the image data in a storing section, comprises steps of face detecting face center detecting, face centroid detecting judging and a permitting. The face detecting step is for detecting a face of the subject based on the image data. The face center detecting step is for detecting a central coordinate of the face in a shooting screen based on the image data of the detected face. The face centroid detecting step is for detecting a centroid coordinate which is a center of all faces based on the central coordinate of each face detected by the face center detecting step when plural faces are detected by the face detecting step. The judging step is for judging whether the central coordinate of each face is inside the shooting screen or not and whether the centroid coordinate is inside a predetermined determination area provided in the shooting screen or not. And the permitting step is for permitting image capturing when the judging step judges that the central coordinate is inside the shooting screen and the centroid coordinate is inside the determination area.

It is preferable that the image capturing method further comprises a step for detecting both eyes of the subject based on the image data of the face detected by the face detecting step and for detecting whether the both eyes are open or not, and the image capturing is permitted when the central coordinate is judged to be inside the shooting screen and the centroid coordinate is judged to be inside the determination area, and the eye detecting step detects that the both eyes are open.

A controlling program of the present invention, for an image capturing device which obtains image data by photo-electrically converting a subject image focused through an imaging optical system and stores the image data in a storing section, controls the image capturing device to perform process of face detecting, face center detecting, face centroid detecting, judging and permitting. The face detecting process is for detecting a face of the subject based on the image data. The face center detecting process is for detecting a central coordinate of the face in a shooting screen based on the image data of the detected face. The face centroid detecting process is for detecting a centroid coordinate which is a center of all faces based on the central coordinate of each face detected by the face center detecting process when plural faces are detected by the face detecting process. The judging process is for judging whether the central coordinate is inside the shooting screen or not and whether the centroid coordinate is inside a predetermined determination area provided in the shooting screen or not. And the permitting process is for permitting image capturing when the central coordinate is judged to be inside the shooting screen and the centroid coordinate is judged to be inside the determination area.

It is preferable that the controlling program further comprises a process for detecting both eyes of the subject based on the image data of the face detected by the face detecting process and for detecting whether the both eyes are open or not, and the image capturing is permitted when the central coordinate is judged inside the shooting screen and the centroid coordinate is judged inside the determination area, and the eye detecting process detects that the both eyes are open.

According to the image capturing device, the image capturing method and the controlling program of the present invention, the face of the subject is detected based on the image data output from the imaging element, the central coordinate of each face is in the shooting screen is calculated based on the image data of the face, the centroid coordinate (the center of the all faces) is calculated based on the central coordinate of each face when there are plural faces, and the image capturing is permitted when the central coordinate is inside the shooting screen and the centroid coordinate is inside the determination area. Accordingly, a bad mistake of image capturing, such as all or a large part of human face is out of the shooting screen when there are plural subjects, can be prevented.

Since the image capturing is permitted when the central coordinate is inside the shooting screen, the centroid coordinate is inside the determination area, and it is detected that the both eyes of the subject are open, an image with a face being outside the shooting screen and a closed eye can be captured.

Since the determination area is set at the center of the shooting screen and has the shape similar to the shooting screen, an up-shot (faces of subjects are captured in close-up) is conveniently captured with a face outside the shooting screen.

Since the subject (user) is informed that the image capturing is permitted when it is judged that the image capturing is permitted, the user is free from anxiety for image capturing.

Since a guidance to persuading the user to change a position of the subject or the image capturing device is given when it is judged that the image capturing cannot be permitted, the subject or the image capturing device will be moved so that the image capturing is permitted. Accordingly, a bad mistake of image capturing, such as all or a large part of human face is out of the shooting screen when there are plural subjects, can be prevented.

Since a size of the determination area is reduced as the number of the detected faces increases, it is prevented a problem that faces tend to run off the shooting screen when the number of faces increases.

Since the image capturing is automatically performed when it is judged that the image capturing is permitted, the user does not need to perform shutter-release operation. Accordingly, it is prevented that the image capturing failures due to camera shake even when the user holds the device with the nondominant hand.

Since the continuous image capturing of plural frames is automatically performed when the image capturing is permitted, a preferable image can be selected from the plural frames and preferentially recorded.

Since the focal distance of the imaging optical system is changed when the detected face size does not correspond with the designated face size, a bad mistake of image capturing, such as all or a large part of human face is out of the shooting screen when there are plural subjects, can be prevented.

Since the face size is designated according to at least one mode selected from the up-shot mode, the bust-shot mode and the full-shot mode, the image capturing can be performed with the size of the face adjusted to the selected mode.

Since another image can be obtained by trimming the captured image, plural images of the subject each of which has a different size can be obtained by single image capturing.

According to the image capturing device, the shooting screen is virtually divided into plural segments, a segment for displaying the face of the subject is designated, the number of image capturing and a capturing interval are set for the self-timer image capturing, the face of the subject is detected and a correct exposure and a focus position is calculated and locked while the self-timer measures the predetermined time, and the image capturing is performed with the set number of image capturing and the capturing interval after the self-timer measures the predetermined time. Accordingly, although at first the user with the natural face needs to stand up in front of the device, he/she can make a desired pose and wearing for the self-portrait image capturing after the predetermined time is passed.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a perspective view of a digital camera of the first embodiment of the present invention;

FIG. 2 is a block diagram of an electrical configuration of the digital camera;

FIG. 3 is an explanatory view showing a state that face central coordinates of two faces are inside a shooting screen and a face centroid coordinate is inside a determination area;

FIG. 4 is an explanatory view showing a state that face central coordinates of three faces are inside the shooting screen and the face centroid coordinate is inside the determination area;

FIG. 5 is a flowchart showing a processing sequence in the first embodiment;

FIG. 6 is a flowchart showing a processing sequence in the second embodiment;

FIG. 7 is a block diagram of an electrical configuration of the third embodiment;

FIG. 8 is a flowchart showing a processing sequence in the third embodiment;

FIG. 9 is a flowchart showing a processing sequence in the fourth embodiment;

FIG. 10 is a flowchart showing a processing sequence in the fifth embodiment;

FIG. 11 is an explanatory view showing the shooting screen in a bust-shot mode in the sixth embodiment;

FIG. 12 is an explanatory view showing the shooting screen in a full-shot mode in the sixth embodiment;

FIG. 13 is a flowchart showing a processing sequence in the sixth embodiment;

FIG. 14 is a flowchart showing a processing sequence in the seventh embodiment;

FIG. 15A is an explanatory view showing the shooting screen of a bust-shot in the eighth embodiment;

FIG. 15B is an explanatory view showing an up-shot image trimmed from the bust-shot image of FIG. 15A;

FIG. 16A is an explanatory view showing the shooting screen of a full-shot in the eighth embodiment;

FIG. 16B is an explanatory view showing a bust-shot image trimmed from the full-shot image of FIG. 16A;

FIG. 16C is an explanatory view showing an up-shot image trimmed from the full-shot image of FIG. 16A;

FIG. 17 is a flowchart showing a processing sequence in the eighth embodiment;

FIG. 18 is an explanatory view showing the shooting screen in the ninth embodiment, which is virtually divided into nine segments;

FIG. 19 is a block diagram of an electrical configuration of the ninth embodiment;

FIG. 20 is a flowchart showing a processing sequence in the ninth embodiment; and

FIG. 21 is an explanatory view showing a state that face central coordinates of plural faces are inside the selected segment.

### DETAILED DESCRIPTION OF THE PREFERRED EMBODIMENTS

A digital camera, which is an image capturing device of the first embodiment of the present invention, is designed such that the central coordinates of a face of each subject is inside a shooting screen and the centroid coordinates (the center of all faces) is inside a determination area positioned at center of the shooting screen, when there are plural subjects in self-portrait mode. Note that when there is only one subject, the central coordinates of a face the subject become the centroid coordinates.

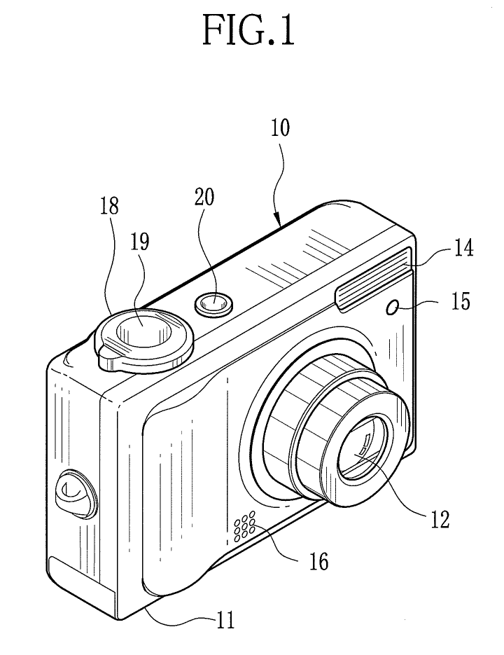

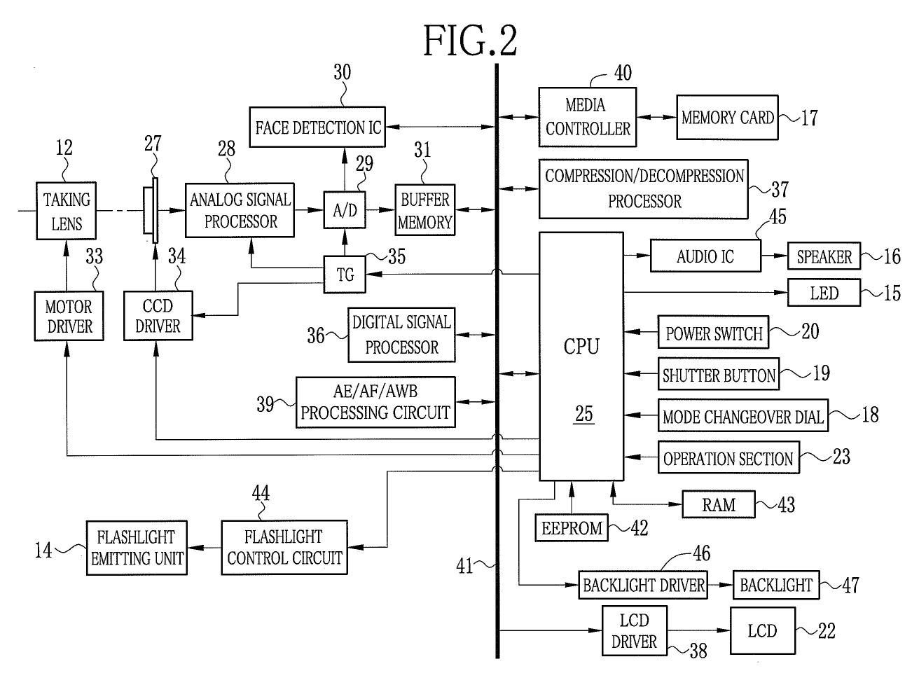

As shown in FIG. 1, a taking lens 12 which is a zoom lens, a flashlight emitting unit 14, an LED 15 and a speaker 16 are provided on a front face of a camera main body 11 of the digital camera 10. In addition, a card slot (not shown) for a memory card 17 (see FIG. 2) is provided at the left-hand side of the camera main body 11.

The LED 15 blinks or continuously lights according to a condition in the self-portrait mode (described later). As described later in detail, the speaker 16 let a user know the condition by audio guidance in the self-portrait mode.

On the upper face of the camera main body 11, there are a mode changeover dial 18 of a ring shape for changing between normal imaging mode, the self-portrait mode, reproduction mode and soon by rotation, a shutter button 19 provided at the center of the mode changeover dial 18, and a power switch 20.

The shutter button 19 has two steps, the first is “half-press” (lightly press the button and keep this state), and the second is “full-press” (further press down the button from the half-pressed state). At the half-press, autofocus (AF) and auto exposure (AE) are locked (AF lock and AE lock), and in the self-portrait mode, face detection is performed and whether image capturing can be performed or not is detected (described later in detail). At the full-press, the image capturing is performed.

On the back face of the camera main body 11, there are a liquid crystal display (LCD) 22 (see FIG. 2) for being used as an electronic viewfinder displaying through images and for displaying preview images of the captured images and reproduced images read from the memory card 17, and an operation section 23 (see FIG. 2) including a zoom button, a multifunction cross key, menu/execution button, display/return button, reproduction mode button and so on.

As shown in FIG. 2, the digital camera 10 further comprises a CPU 25, a CCD 27, an analog signal processor 28, an A/D converter 29, a face detection IC 30, a buffer memory 31, a motor driver 33, a CCD driver 34, a timing generator (TG) 35, a digital signal processor 36, a compression/decompression processor 37, an LCD driver 38, an AE/AF/AWB processing circuit 39, a media controller 40, a data bus 41, an EEPROM 42, a RAM 43, a flashlight control circuit 44, an audio IC 45, a backlight driver 46 and a backlight 47, in addition to the taking lens 12, the flashlight emitting unit 14, the LED 15, the speaker 16, the memory card 17, the mode changeover dial 18, the shutter button 19, the power switch 20, the LCD 22 and the operation section 23 which are described above.

In the EEPROM 42, control programs for controlling each section of the digital camera 10, data for various control and so on are manufacturer-supplied. In the RAM 43, working data is temporally stored. The CPU 25 controls each section with use of these control programs, data for various control and so on.

The taking lens 12 includes a lens group having a magnification lens, a focus lens and so on, an aperture stop for regulating imaging light amount, a motor for moving the magnification lens and the focus lens in the optical axis direction, and a motor for driving the aperture stop. The motor driver 33 is controlled by the CPU 25 to generate drive signal for driving the motors in the taking lens 12.

The CCD 27 is disposed behind the taking lens 12. Subject light passed through the taking lens 12 is focused on a light-receiving surface of the CCD 27. The CCD 27 converts the optical image into electric image signal. Note that an image pickup element of CMOS type can be used instead of the CCD 27.

The CCD driver 34 generates drive signal for driving the CCD 27 under control of the CPU 25. The CCD 27 is driven by the drive signal. For displaying the through image, image signal of a field image (even field or odd field) is read out from the CCD 27 and fed into the analog signal processor 28. During the image capturing, image signal of a frame is read from the CCD 27 and fed into the analog signal processor 28.

The analog signal processor 28 is constituted of a correlated double sampling circuit (CDS) and an amplifier (AMP). In the CDS, noises are removed from the image signal. In the AMP, gain of the image signal is adjusted according to predetermined ISO sensitivity. Then the image signal is output from the analog signal processor 28 to the A/D converter 29.

The A/D converter 29 converts the image signal of analog into image data of digital (CCDRAW data), feeds the image data to the face detection IC 30 and stores the data into the buffer memory 31. The TG 35 provides timing signals to the CCD driver 34, the analog signal processor 28 and the A/D converter 29 in accordance with the command from the CPU 25, and these components operate in synchronization with the timing signals.

In the self-portrait mode, the face detection IC 30 performs the face detection according to the image data, and detects a central coordinate of a face (hereinafter referred as the face central coordinate). When there are plural faces, a centroid coordinate of all faces (hereinafter referred as the face centroid coordinate) is calculated. In the face detection, an area containing many pixels of flesh color assumed as skin is extracted as a face image. To determine the face central coordinate, coordinate of a point at equal distance from anywhere of contour of the face image is calculated. It may be that eyes are detected from the face and the center point between the eyes is determined as the face central coordinate.

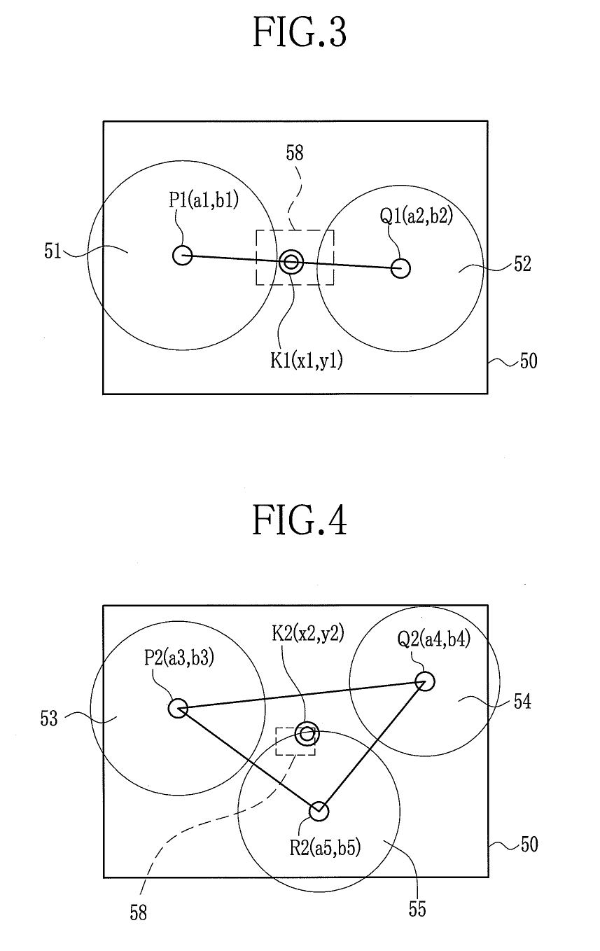

A method for determining the face centroid coordinate is described with reference to FIG. 3 and FIG. 4. When there are two subjects, as shown in FIG. 3, following formula 1 and formula 2 become true under following conditions:

the face central coordinate of a face 51 in the shooting screen 50 is P1 (a1, b1);

the face central coordinate of a face 52 in the shooting screen 50 is Q1 (a2, b2); and

the face centroid coordinate of the faces 51 and 52 is K1 (x1, y1).

Note that the face central coordinates and the face centroid coordinate are shown as circles and a double circle having certain sizes in each FIG. 3 and FIG. 4 for explanation, however, the center points of these circles and double circle are actually the face central coordinates and the face centroid coordinate.

x1=(a1+a2)/2 [formula 1]

y1=(b1+b2)/2 [formula 2]

When there are three subjects, as shown in FIG. 4, following formula 3 and formula 4 become true under following conditions:

the face central coordinate of a face 53 in the shooting screen 50 is P2 (a3, b3);

the face central coordinate of a face 54 in the shooting screen 50 is Q2 (a4, b4);

the face central coordinate of a face 55 in the shooting screen 50 is R2 (a5, b5); and

the face centroid coordinate of the faces 53 to 55 is K2 (x2, y2).

x2=(a3+a4+a5)/2 [formula 3]

y2=(b3+b4+b5)/2 [formula 4]

When there are four or more subjects, as same as above, the face centroid coordinate (x, y) can be calculated by following formula 5 and formula 6.

x=(sum of x coordinates of centers of all faces)/number of faces [formula 5]

y=(sum of y coordinates of centers of all faces)/number of faces [formula 5]

The face central coordinates and the face centroid coordinate obtained by the face detection IC 30 are input to the CPU 25 through the data bus 41. The CPU 25 judges whether the face central coordinates of all faces are inside the shooting screen 50 or not, and also judges whether the face centroid coordinate is inside a determination area 58 or not, which is set at the center of the shooting screen and has a shape similar to the shooting screen, or not. Note that since the determination area 58 is set at the center of the shooting screen 50, this embodiment is preferably applied for up-shot (faces of subjects are captured in close-up).

As shown in following table 1, the size of the determination area 58 becomes smaller as the number of detected faces increases. A look-up table showing a relation between the size of the determination area 58 and the number of detected faces is contained in the EEPROM 42. Since all of the face central coordinates are inside the shooting screen 50 and the face centroid coordinate is positioned more closer to the center of the shooting screen 50 as the number of detected faces increases, it is prevented that some of the faces run off the shooting screen 50.

TABLE 1

| Number of faces | Size of determination area |
|---|---|
| 1 | 30% of shooting screen |
| 2 | 20% of shooting screen |
| 3 | 10% of shooting screen |

In this embodiment, when there are four or more faces, the size of the determination area 58 is 10% of the shooting screen 50, as same as when there are three faces. However, the size of the determination area 58 may be changed for example to 8% of the shooting screen when there are four faces, to 7% (five faces), to 6% (six faces).

The CPU 25 allows the image capturing when the face central coordinates of all faces are inside the shooting screen 50 and the face centroid coordinate is inside the determination area 58. The CPU 25 drives the LED 15 to continuously light and drives the audio IC 45 to run audio guidance from the speaker 16. Accordingly, the user notices that the image capturing is allowed. As sentences of the audio guidance, for example there are “image capturing is allowed” and “all faces are inside screen”. When the shutter button 19 is full-pressed at this state, the CPU 25 executes the image capturing.

When the face central coordinates of some faces are outside the shooting screen 50 or the face centroid coordinate is outside the determination area 58, the CPU 25 drives the LED 15 to blink and drives the audio IC 45 to run audio guidance from the speaker 16. Accordingly, the user notices that the image capturing will be failed at this state. As sentences of the audio guidance, for example there are “face runs off screen” and “please come close together”. In addition, it is possible to inform the user about direction for moving the digital camera 10 and so on by audio guidance.

In the self-portrait mode, there is no need to see the LCD 22. Accordingly, to save energy, the CPU 25 turns off the backlight 47 of the LCD 22 through the backlight driver 46. Note that a timing to turn off the backlight 47 is preferably right after selecting the self-portrait mode or right after half-press of the shutter button 19 in the self-portrait mode.

The digital signal processor 36 is composed of a white balance (WB) adjusting circuit, a γ conversion circuit, a YC conversion circuit and soon. The image data stored in the buffer memory 31 is subjected to adjustment of white balance and color correction. Then the image data is subjected to gradation conversion processing in accordance with predetermined Y conversion parameter, and then the image data represented by R,G,B colors is converted into the image data represented by luminance (Y) and color difference (Cr, Cb).

The image data of the field image (for displaying through image) output from the digital signal processor 36 is temporally stored in the buffer memory 31, and then read out from the buffer memory 31 and converted into composite signal of analog by the LCD driver 38, to be displayed as the through image on the LCD 22. The user can perform framing of the subject with observing the through image displayed on the LCD 22.

The image data of the frame image (in image capturing) output from the digital signal processor 36 is temporally stored in the buffer memory 31, and then read out from the buffer memory 31 and compressed in a certain compression format (such as JPEG format) by the compression/decompression processor 37. The media controller 40 controls the memory card 17 to record the image data compressed by the compression/decompression processor 37.

The flashlight emitting unit 14 is an electronic flash with use of a xenon lamp, and is controlled by the flashlight control circuit 44. The flashlight control circuit 44 has a lighting circuit for feeding high voltage current to the xenon lamp, to control light emission from the xenon lamp. For example, full-emission of light is performed in the image capturing, and light emission for light control (low-emission of light) is performed for the AE before the image capturing.

The AE/AF/AWB processing circuit 39 performs exposure calculation, detection of focal point, and white balance amount calculation. In the exposure calculation, subject brightness is detected based on the luminance signal Y, and correct exposure is calculated based on the subject brightness. In addition, the AE/AF/AWB processing circuit 39 determines a shutter speed, an aperture value, an imaging sensitivity, whether the flashlight emits or not, and so on according to the calculated correct exposure. The results data are input into the CPU 25. The CPU 25 controls the CCD driver 34, the motor driver 33, the flashlight control circuit 44 and so on according to the results data.

When the AE/AF/AWB processing circuit 39 performs the detection of focal point, high frequency component of spacial frequency of the image data stored in the buffer memory 31 is integrated. The integration value is output into the CPU 25 as focus evaluation value. The CPU 25 controls the motor driver 33 to move the focus lens of the taking lens 12 in the optical direction, such that the integration value obtained by the AE/AF/AWB processing circuit 39 is maximized. In addition, the AE/AF/AWB processing circuit 39 detects the white balance amount from the image data and outputs the result to the CPU 25.

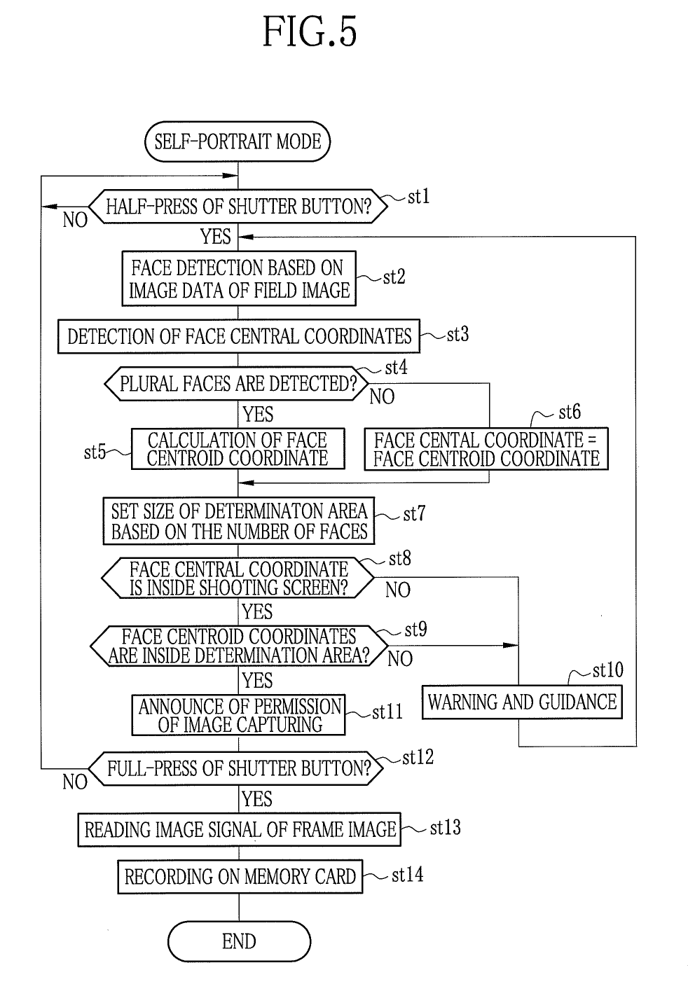

Next, the self-portrait mode of the above embodiment is explained with reference to a flowchart of FIG. 5. The user operates the power switch 20 to turn on the digital camera 10, and operates the mode changeover dial 18 to set the self-portrait mode. Then the CPU 25 turns off the backlight 47 thorough the backlight driver 46.

For example, in taking a self-portrait of three members together, one of the three holds the digital camera 10 with the taking lens 12 facing the three members and half-presses the shutter button 19 (st1). The CCD driver 34 reads the image signal of the field image from the CCD 27, and inputs the image signal into the analog signal processor 28. The image signal is subjected to the noise removal and the gain adjustment in the analog signal processor 28, and is converted into the image data of digital at the A/D converter 29.

The image data is stored in the face detection IC 30 and the buffer memory 31. The face detection IC detects the faces 53 to 55 based on the image data of the field image (st2), and calculates the face central coordinates P2 (a3, b3) of the face 53, the face central coordinates Q2 (a4, b4) of the face 54, and the face central coordinates R2 (a5, b5) of the face 55 (st3).

Since three faces are detected (st4), the face centroid coordinate K2 (x2, y2) of the faces 53 to 55 is calculated based on the face central coordinates P2, Q2 and R2 (st5). In case that there is one face, its central coordinates become the face centroid coordinates (st6). The face central coordinates P2, Q2 and R2, and the face centroid coordinate K2 are sent to the CPU 25 from the face detection IC 30.

The CPU 25 finds that there are three faces from the face central coordinates P2, Q2 and R2, and sets the size of the determination area 58 to 10% of the shooting screen 50 (corresponding to three faces) with referring to the EEPROM 42 (st7).

The CPU 25 judges whether all of the face central coordinates P2, Q2 and R2 are inside the shooting screen 50 or not (st8), and judges whether the face centroid coordinate K2 is inside the determination area 58 or not (st9).

When the result of judgment is negative, the CPU 25 drives the LED 15 to blink and drives the audio IC 45 to run audio guidance such as “please come close together” from the speaker 16, so that the notice and guidance are given to the user (st10).

When the results of both judgments are positive, the CPU 25 drives the LED 15 to continuously light and drives the audio IC 45 to run audio guidance such as “image capturing is allowed” from the speaker 16, so that the user is induced to perform the image capturing (st11).

When the shutter button 19 is full-pressed (st12), the CPU 25 controls the CCD driver 34 such that the image capturing is performed at the highest shutter speed in a range of correct exposure so as to prevent camera shaking, and the CCD driver 34 reads out the image signal of the frame image from the CCD 27 (st13). The image signal is input into the analog signal processor 28. After the reading out of the image signal, the LED 15 is turned off.

The image signal of the frame is subjected to the noise removal and the amplification. Then the image signal is converted into the image data of digital at the A/D converter 29 and temporally stored in the buffer memory 31. Then the image data is sent to the digital signal processor 36 and subjected to the various processes. After the processes, the image data is compressed by the compression/decompression processor 37, and stored in the memory card 17 (st14).

According to this embodiment of the digital camera 10, at least the center of each of the faces is inside the shooting screen for the image capturing even when there are plural subjects as described above. Accordingly, a bad mistake of image capturing, such as large part of somebody's face is out of the shooting screen, can be prevented.

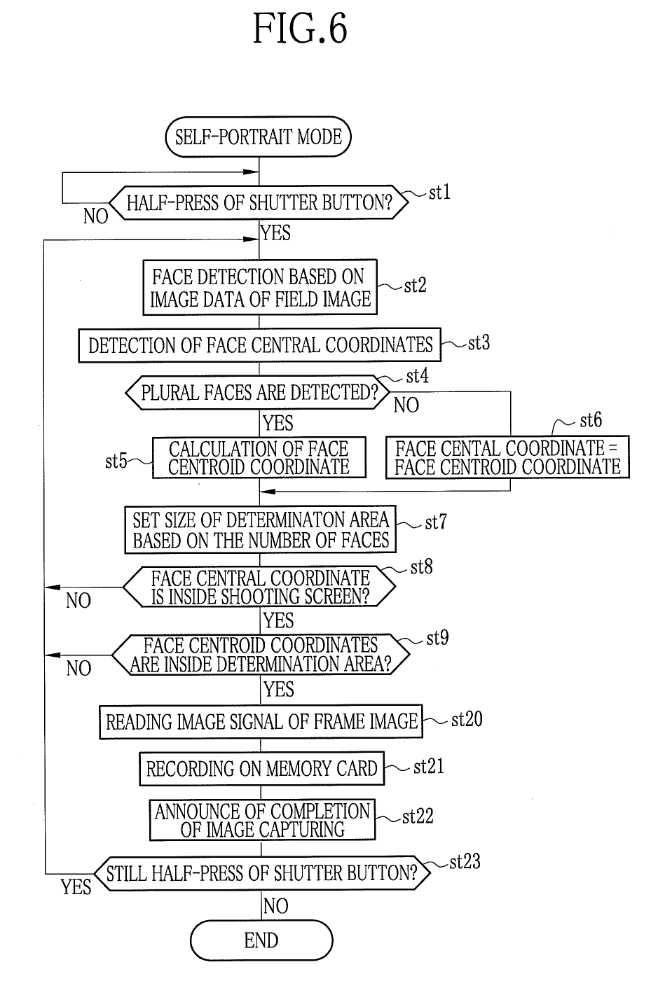

Next, the second embodiment of the present invention is described. In this embodiment, when at least each center of faces of all subjects is inside the shooting screen while the shutter button 19 is half-pressed, the digital camera 10 automatically performs the image capturing. Since this embodiment has the same appearance and electronic configuration as the first embodiment, only a flowchart of FIG. 6 is referred for the explanation. In this flowchart, the steps same as the first embodiment have the same step number as the first embodiment and these steps are briefly explained or not explained. In the same way, following embodiments will be explained mainly in parts different from other embodiments, and the parts same as the former-explained embodiment will be briefly explained or not explained.

When both of the judgment results in the steps 8 and 9 are positive, the CPU 25 controls the CCD driver 34 such that the image capturing is performed at the highest shutter speed in a range of correct exposure so as to prevent camera shaking, and the CCD driver 34 reads out the image signal of the frame image from the CCD 27 (st20). The image signal is input into the analog signal processor 28.

The image signal of the frame is subjected to the noise removal and the amplification in the analog signal processor 28. Then the image signal is converted into the image data of digital at the A/D converter 29. Then the image data is sent to the digital signal processor 36 and subjected to the various processes. After the processes, the image data is compressed by the compression/decompression processor 37, and stored in the memory card 17 (st21).

Right after the image capturing, the CPU 25 drives the LED 15 to continuously light and drives the audio IC 45 to run audio guidance such as “image capturing is completed” from the speaker 16, so that the user is noticed that the image capturing is completed (st22). Then the LED 15 is turned off.

After that, the CPU 25 confirms whether the shutter button 19 is still half-pressed or not (st23). When the shutter button 19 is still half-pressed, the sequence is executed again from the step 2. When the half-press of the shutter button 19 is released, the sequence of the self-portrait mode is ended.

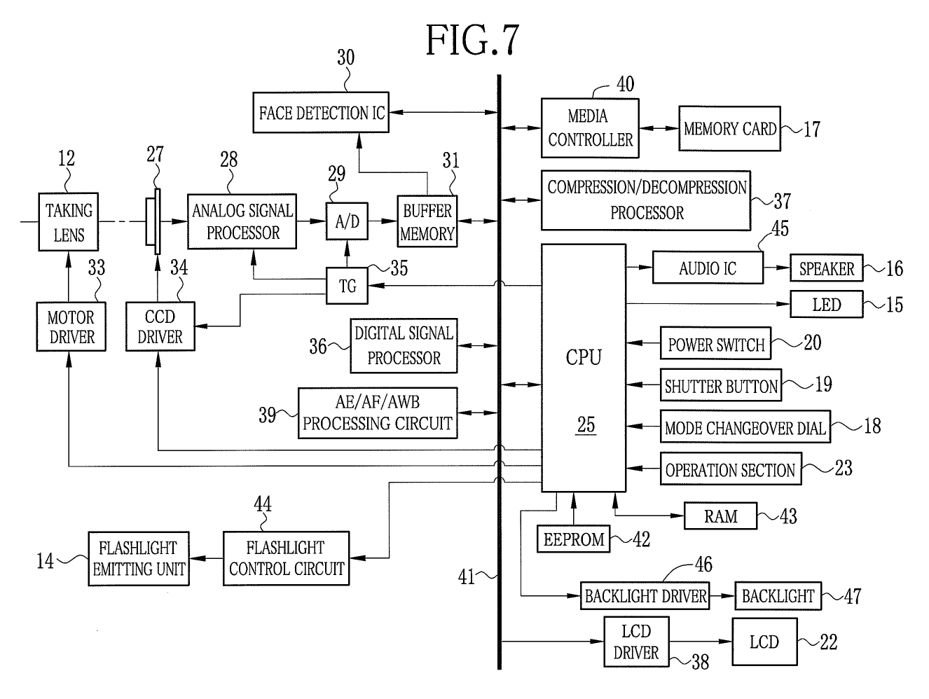

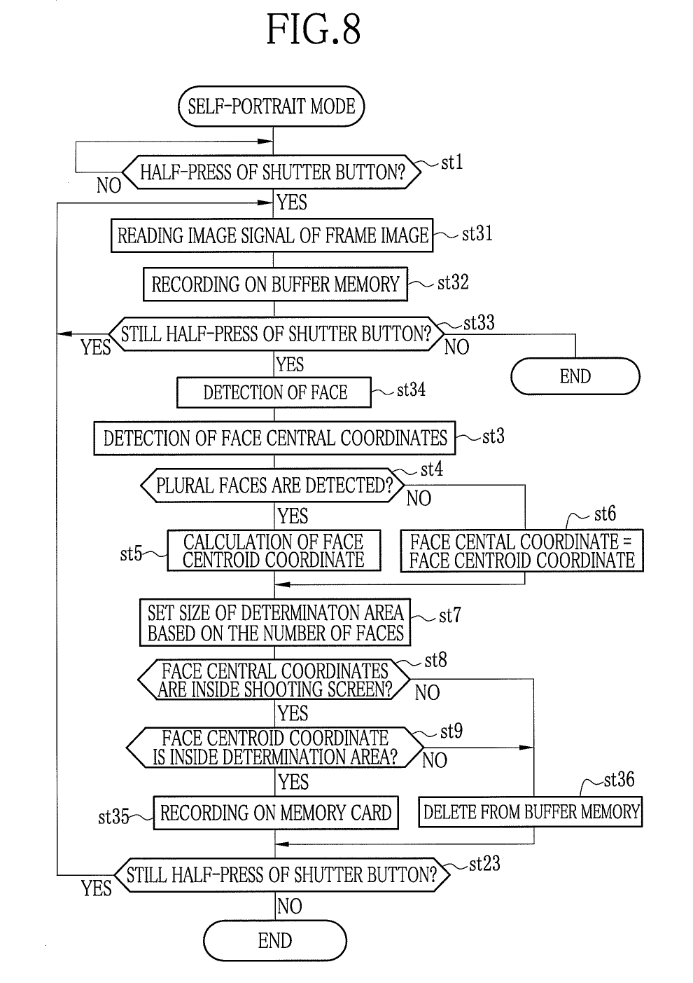

Next, the third embodiment of the present invention is described with reference to FIG. 7 and FIG. 8. In this embodiment, while the shutter button 19 is half-pressed in the self-portrait mode, the image capturing is repeatedly performed and the face detection is performed for each image data stored in the buffer memory 31. Note that an electronic configuration of this embodiment shown in FIG. 7 is almost same as the first embodiment. However, this embodiment is different from the first embodiment in that the image data temporally stored in the buffer memory 31 is fed to face detection IC 30.

When the shutter button 19 is half-pressed in the self-portrait mode (st1), the CPU 25 controls the CCD driver 34 such that the image capturing is performed at the highest shutter speed in a range of correct exposure so as to prevent camera shaking, and the CCD driver 34 reads out the image signal of the frame image from the CCD 27 (st31). The image signal is input into the analog signal processor 28.

The image signal of the frame image is subjected to the noise removal and the amplification in the analog signal processor 28. Then the image signal is converted into the image data of digital at the A/D converter 29. Then the image data is stored in the buffer memory 31 (st32).

The sequence from the reading of the frame image from the CCD 27 to the storing of the image data into the buffer memory 31 is repeatedly performed while the shutter button 19 is half-pressed (st33), and the image data is sequentially stored in the buffer memory 31. However, when the buffer memory 31 becomes full, the old image data is deleted in chronological order for storing the new image data.

The face detection IC 30 performs the face detection from the image data stored in the buffer memory 31 (st34), and detects the face central coordinate of the detected face (st3). When there are plural faces (st4), the face centroid coordinates of the faces are calculated (st5). When there is one face (st4), the face central coordinate of the face become the face centroid coordinate (st6).

The CPU 25 determines the size of the determination area 58 according to the number of faces (st7), and judges whether all of the face central coordinate are inside the shooting screen 50 or not (st8) and whether the face centroid coordinate is inside the determination area 58 or not (st9).

The image data satisfying the both conditions is sent to the digital signal processor 36 from the buffer memory 31 and subjected to the various processes. After the processes, the image data is compressed by the compression/decompression processor 37, and stored in the memory card 17 (st35). The image data not satisfying at least one of conditions is deleted from the buffer memory 31 (st36).

After that, the CPU 25 confirms whether the shutter button 19 is still half-pressed or not (st23). When the shutter button 19 is still half-pressed, the sequence is executed again from the step 31. When the half-press of the shutter button 19 is released, the sequence of the self-portrait mode is ended.

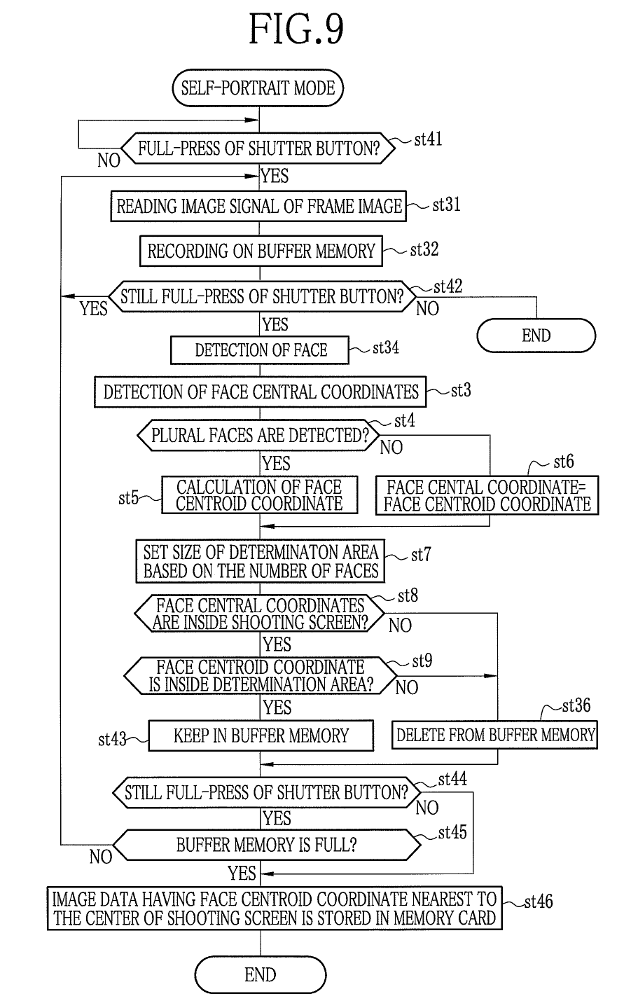

Next, the fourth embodiment of the present invention is described with reference to a flowchart of FIG. 9. In this embodiment, while the shutter button 19 is full-pressed in the self-portrait mode, the image capturing is repeatedly performed, the face detection is performed for each image data stored in the buffer memory 31, and the image data having the face centroid coordinate nearest to the center of the shooting screen 50 is recorded in the memory card 17.

When the shutter button 19 is full-pressed in the self-portrait mode (st41), the CPU 25 controls the CCD driver 34 such that the image capturing is performed at the highest shutter speed in a range of correct exposure so as to prevent camera shaking, and the CCD driver 34 reads out the image signal of the frame image from the CCD 27 (st31). The image signal is input into the analog signal processor 28.

The image signal of the frame image is subjected to the noise removal and the amplification in the analog signal processor 28. Then the image signal is converted into the image data of digital at the A/D converter 29. Then the image data is stored in the buffer memory 31 (st32).

The sequence from the reading of the frame image from the CCD 27 to the storing of the image data into the buffer memory 31 is repeatedly performed while the shutter button 19 is full-pressed (st42), and the image data is sequentially stored in the buffer memory 31. However, when whether the buffer memory 31 is full or not is checked for storing the image data in the buffer memory 31 and it is found that the buffer memory 31 is full, it is preferable that the old image data is deleted in chronological order for storing the new image data. Alternatively, it is also preferable that higher priority order is given to the image data having the face central coordinates closer to the center of the shooting screen 50 and the image data of the lowest priority order is removed at first from the buffer memory 31. According to this process, the image data of higher priority can be kept in the buffer-memory 31.

The face detection IC 30 performs the face detection from the image data stored in the buffer memory 31 (st34), and detects the face central coordinate of the detected face (st3). When there are plural faces (st4), the face centroid coordinates of the faces are calculated (st5). When there is one face (st4), the face central coordinate of the face become the face centroid coordinate (st6).

The CPU 25 determines the size of the determination area 58 according to the number of faces (st7), and judges whether all of the face central coordinates are inside the shooting screen 50 or not (st8) and whether the face centroid coordinate is inside the determination area 58 or not (st9).

The image data satisfying the both conditions is kept in the buffer memory 31 (st43). The image data not satisfying at least one of conditions is deleted from the buffer memory 31 (st36).

After that, the CPU 25 confirms whether the shutter button 19 is still full-pressed or not (st44). When the shutter button 19 is still full-pressed, the CPU 25 confirms whether the buffer memory 31 is full or not (st45).

When the buffer memory 31 is full or the shutter button 19 is released, the CPU 25 sends the image data, having the face centroid coordinate nearest to the center of the shooting screen 50, to the digital signal processor 36. The image data is subjected to the various processes in the digital signal processor 36. After the processes, the image data is compressed by the compression/decompression processor 37, and stored in the memory card 17 (st46).

When the shutter button 19 is still full-pressed (st44) and the buffer memory 31 is not full (st45), the sequence is executed again from the step 31.

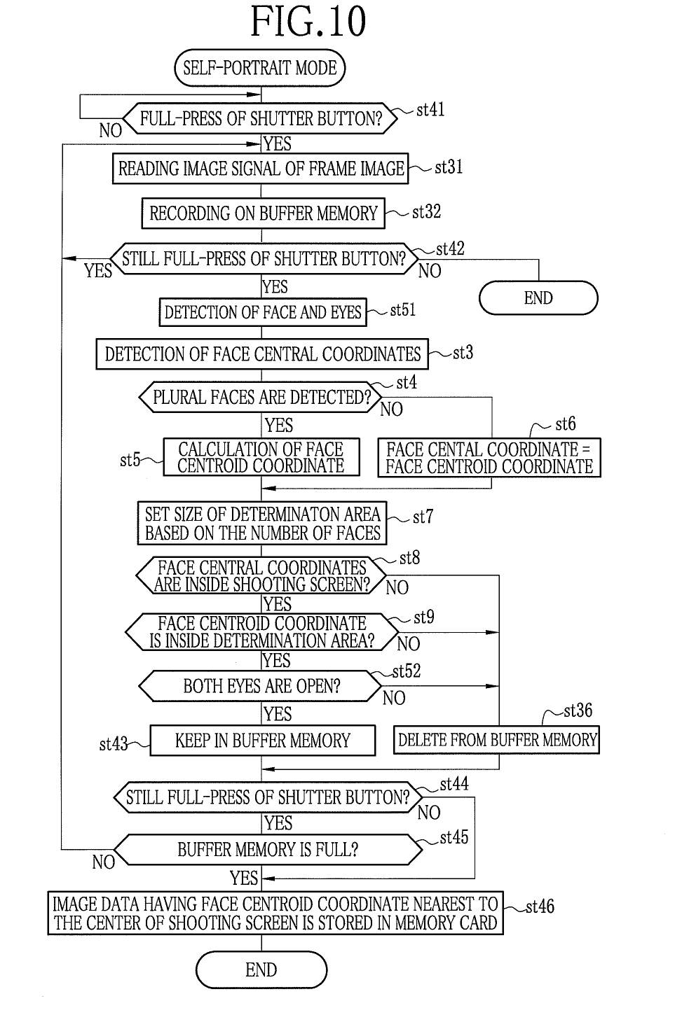

Next, the fifth embodiment of the present invention is described with reference to a flowchart of FIG. 10. In this embodiment, steps for judging whether eyes of a face are opened or not are added to the sequence of the fourth embodiment.

The face detection IC 30 detects faces and eyes from the image data stored in the buffer memory 31 (st51). The face detection IC 30 detects regions where there are white pixels assumed as the white of the eye and regions where there are black pixels assumed as the black of the eye, and calculates position coordinates of the both eyes from these regions. In addition, when the color of pixels in the regions detected as the both eyes is turned to flesh color from white or black, it is detected that the eyes are closed.

The CPU 25 judges whether all of the face central coordinates are inside the shooting screen 50 or not (st8), whether the face centroid coordinate is inside the determination area 58 or not (st9), and whether the both eyes are opened or not (st52). The image data satisfying all of the three conditions is kept in the buffer memory 31 (st43). The image data not satisfying at least one of conditions is deleted from the buffer memory 31 (st36).

In this embodiment, when whether the buffer memory 31 is full or not is checked for storing the image data in the buffer memory 31 and it is found that the buffer memory 31 is full, it is preferable that the old image data is deleted in chronological order for storing the new image data. Alternatively, it is also preferable that higher priority order is given to the image data having the face central coordinates closer to the center of the shooting screen 50 and the image data of the lowest priority order is removed at first from the buffer memory 31. According to this process, the image data of higher priority can be kept in the buffer memory 31.

Next, the sixth embodiment of the present invention is described. In this embodiment, there are an up-shot mode in which a closeup of a face of a subject is captured, a bust-shot mode in which an upper body of a subject is captured, and a full-shot mode in which a whole body of a subject is captured. Note that since the up-shot mode is same as the first to fifth embodiments, further explanations for the up-shot mode are omitted.

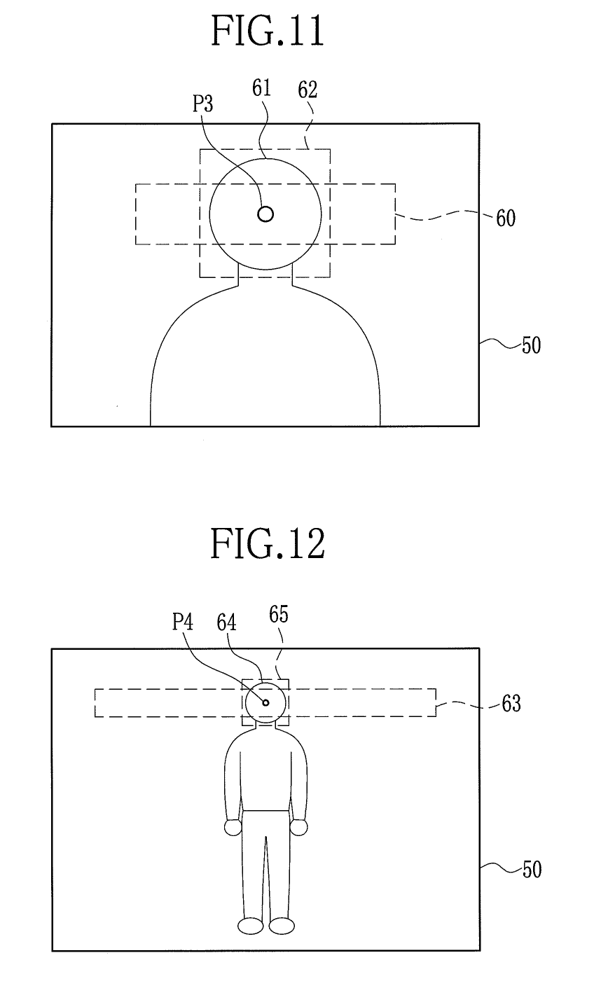

In the bust-shot mode, as shown in FIG. 11, a determination area 60 for the bust-shot and a face defining area 62 for the bust-shot are provided in an upper section of the shooting screen 50. The determination area 60 has a rectangular shape elongated along the horizontal direction, in which face central coordinates P3 of the subject need to be positioned. The face defining area 62 has a nearly square shape and defines a size of a face contour 61. When the face central coordinate P3 is inside the determination area 60 and the size of the face contour 61 is maximized inside the face defining area 62, the bust-shot image will be well balanced.

In the full-shot mode, as shown in FIG. 12, a determination area 63 for the full-shot and a face defining area 65 for the full-shot are provided in an upper section of the shooting screen 50. The determination area 63 has a rectangular shape elongated along the horizontal direction and a narrower width than the determination area 60, in which face central coordinate P4 of the subject need to be positioned. The face defining area 65 has a nearly square shape smaller than the face defining area 62 and defines a size of a face contour 64. When the face central coordinates P4 is inside the determination area 63 and the size of the face contour 64 is maximized inside the face defining area 65, the full-shot image will be well balanced.

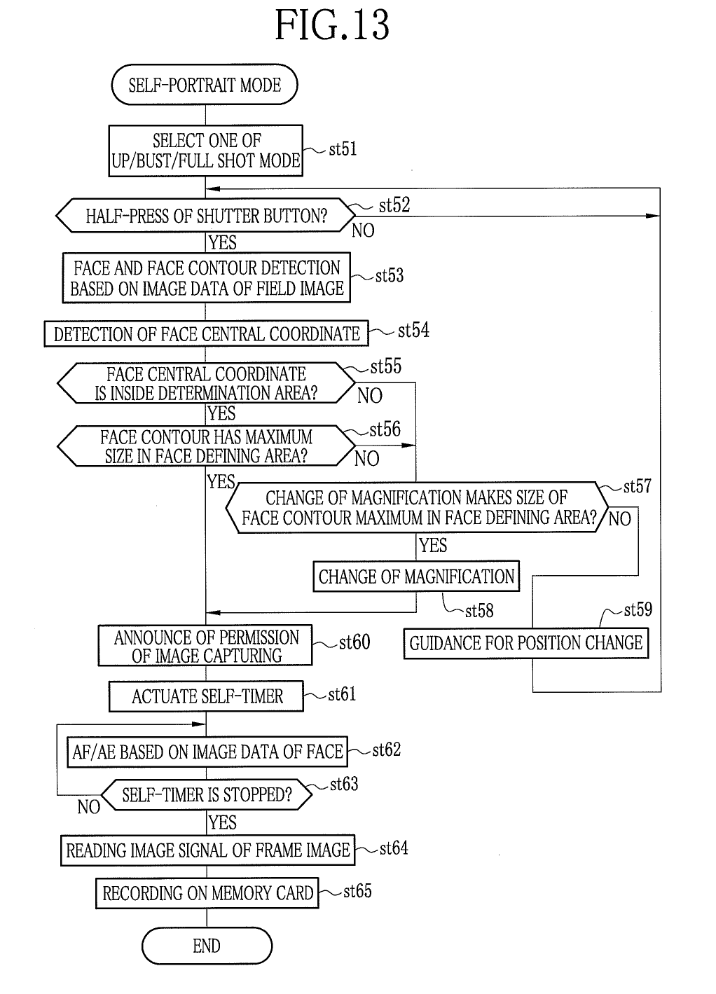

In a flowchart of this embodiment shown in FIG. 13, after the self-portrait mode is set, one of the up-shot mode, bust-shot mode and the full-shot mode is selected in a setting screen on the LCD 22 (st51). In this embodiment, the digital camera 10 is preferably used with attached to a tripod.

When the bust-shot mode is selected for example (st51) and the shutter button 19 is half-pressed (st52), the CCD driver 34 reads the image signal of the field image from the CCD 27, and inputs the image signal into the analog signal processor 28. The image signal is subjected to the noise removal and the gain adjustment in the analog signal processor 28, and is converted into the image data of digital at the A/D converter 29.

The image data is stored in the face detection IC 30 and the buffer memory 31. The face detection IC detects a face of the subject and the face contour 61 (st53) based on the image data of field image, and calculates the face central coordinate P3 based on the face contour 61 (st54).

The CPU 25 judges whether the face central coordinate P3 is inside the determination area 60 for the bust-shot or not (st55), and whether the face contour 61 has the maximum size inside the face defining area 62 or not (st56).

When at least one of the judgment results is negative, the CPU 25 judges whether the negative result can turn to positive by changing the magnification of the taking lens 12 or not (st57). For example in case the CPU 25 finds that the both judgment results become positive when the magnification of the taking lens 12 is changed to the wide end, the magnification change is performed (st58).

In case the CPU 25 finds that the negative result is still remained even when the magnification of the taking lens 12 is changed (st57), the CPU 25 drives the LED 15 to blink and drives the audio IC 45 to run audio guidance such as “please take a step back” from the speaker 16, so that guidance for changing a standing position is given to the user (st59).

When the results of both judgments are positive, the CPU 25 drives the LED 15 to continuously light and drives the audio IC 45 to run audio guidance such as “image capturing is allowed” from the speaker 16 to the user (st60). Then the CPU 25 actuates a self-timer (not shown) (st61).

The AE/AF/AWB processing circuit 39 calculates a correct exposure based on the image data of the face, and determines a shutter speed, an aperture value, an imaging sensitivity, whether the flashlight emits or not, and so on according to the calculated correct exposure. The results data are input into the CPU 25. The CPU 25 controls the CCD driver 34, the motor driver 33, the flashlight control circuit 44 and so on according to the results data (st62).

The CPU 25 controls the motor driver 33 to move the focus lens of the taking lens 12 in the optical direction, such that the integration value of high frequency component obtained by the AE/AF/AWB processing circuit 39 is maximized (st62).

After certain amount of time is passed (for example ten seconds) and the movement of the self-timer is finished (st63), the CPU 25 controls the CCD driver 34 to read out the image signal of the frame image from the CCD 27 (st64). The image signal is input into the analog signal processor 28. After the reading out of the image signal, the LED 15 is turned off.

The image signal of the frame is subjected to the noise removal and the amplification. Then the image signal is converted into the image data of digital at the A/D converter 29 and temporally stored in the buffer memory 31. Then the image data is sent to the digital signal processor 36 and subjected to the various processes. After the processes, the image data is compressed by the compression/decompression processor 37, and stored in the memory card 17 (st65). Note that the image capturing in the full-shot mode is performed according to the same sequence as the bust-shot mode.

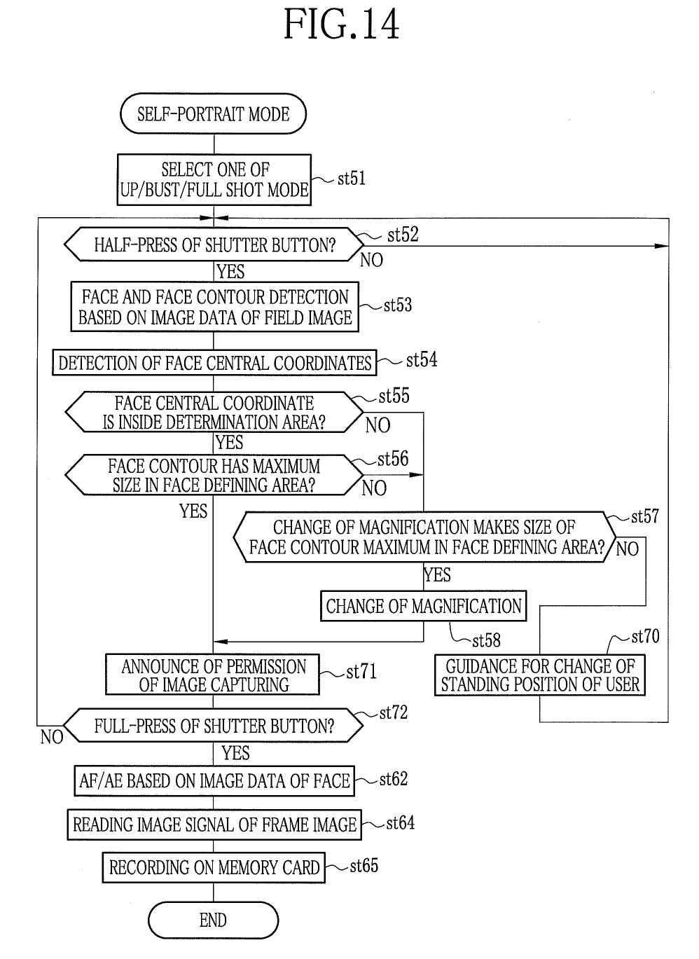

Next, the seventh embodiment of the present invention is described with reference to a flowchart of FIG. 14. In this embodiment, there are the up-shot mode, the bust-shot mode and the full-shot mode as same as the sixth embodiment. However, in the seventh embodiment, an image of the user is captured mainly by anyone else holding the digital camera 10. Note that since the up-shot mode is same as the first to fifth embodiments, further explanations for the up-shot mode are omitted. In addition, in this embodiment, the backlight 47 of the LCD 22 is still turned on even in the self-portrait mode.

For example, the bust-shot mode is selected (st51) and the shutter button 19 is half-pressed (st52). The CPU 25 judges whether the face central coordinate P3 is inside the determination area 60 for the bust-shot or not (st55), and whether the size of the face contour 61 is maximized inside the face defining area 62 or not (st56). When at least one of the judgment results is negative, the CPU 25 judges whether the negative result can turn to positive by changing the magnification of the taking lens 12 or not (st57).

For example in case the CPU 25 finds that the both judgment results become positive when the magnification of the taking lens 12 is changed to the wide end, the magnification change is performed (st58). In case the CPU 25 finds that the negative result is still remained even when the magnification of the taking lens 12 is changed (st57), the CPU 25 drives the audio IC 45 to run audio guidance such as “please take a step back” from the speaker 16, so that guidance for changing a standing position is given to the user (st70).

When the results of both judgments are positive, the CPU 25 drives the audio IC 45 to run audio guidance such as “image capturing is allowed” from the speaker 16 to the user (st71). After the user full-presses the shutter button 19 (st72), the AE/AF/AWB processing circuit 39 calculates a correct exposure based on the image data of the face, and determines a shutter speed, an aperture value, an imaging sensitivity, whether the flashlight emits or not, and so on according to the calculated correct exposure. The results data are input into the CPU 25 (st62).

The CPU 25 controls the CCD driver 34, the motor driver 33, the flashlight control circuit 44 and so on according to the results data (st62). In addition, the CPU 25 controls the motor driver 33 to move the focus lens of the taking lens 12 in the optical direction, such that the integration value of high frequency component obtained by the AE/AF/AWB processing circuit 39 is maximized (st62).

Then the CPU 25 controls the CCD driver 34 to read out the image signal of the frame image from the CCD 27 (st64). The image signal is input into the analog signal processor 28. The image signal of the frame is subjected to the noise removal and the amplification. Then the image signal is converted into the image data of digital at the A/D converter 29. Then the image data is sent to the digital signal processor 36 and subjected to the various processes. After the processes, the image data is compressed by the compression/decompression processor 37, and stored in the memory card 17 (st65). Note that the image capturing in the full-shot mode is performed according to the same sequence as the bust-shot mode.

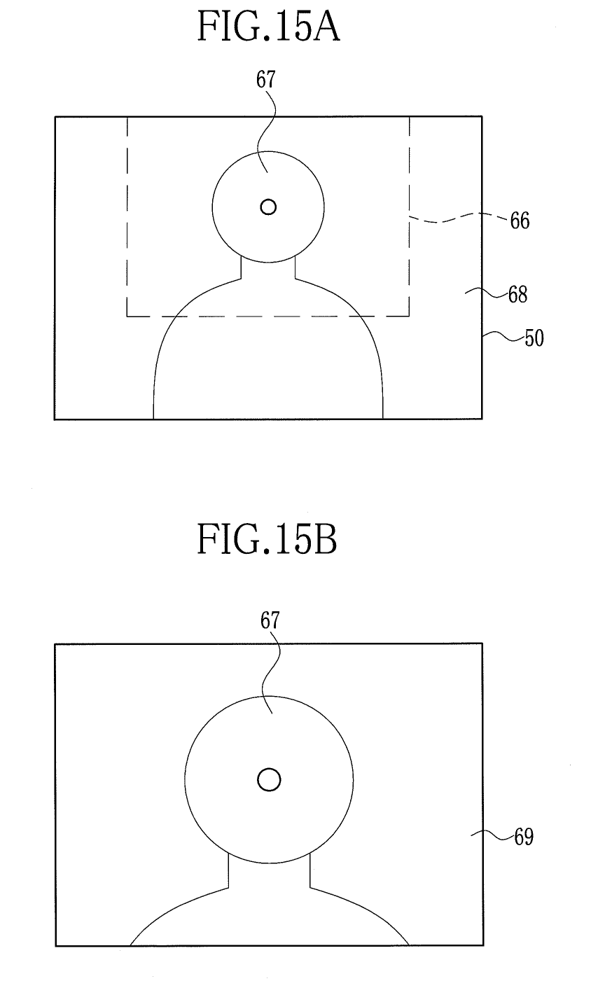

Next, the eighth embodiment of the present invention is described with reference to FIG. 15 to FIG. 17. In this embodiment, there are the up-shot mode, the bust-shot mode and the full-shot mode as same as the seventh embodiment. In addition, both the up-shot and the bust-shot, or all of the up-shot, the bust-shot and the full-shot can be obtained at one image capturing. Note that since the up-shot mode is same as the first to fifth embodiments, explanations for when only the up-shot mode is selected are omitted. In addition, in this embodiment, the backlight 47 of the LCD 22 is still turned on even in the self-portrait mode.

When the up-shot mode and the bust-shot mode are selected at the same time, at first the image capturing is performed in the bust-shot mode to obtain a bust-shot image 68 in the same way as the sixth embodiment (see FIG. 15A). Then an up-shot image 69 is trimmed from the bust-shot image 68 with use of a trimming frame 66 which covers a face 67 of a subject (see FIG. 15B). The obtained bust-shot image 68 and up-shot image 69 are stored in the memory card 17.

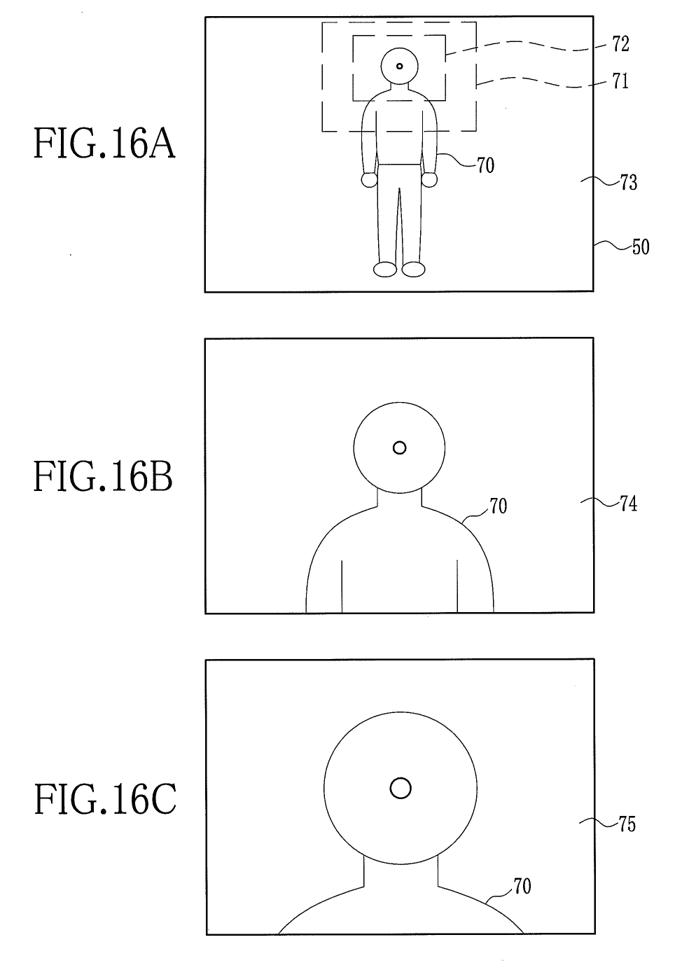

When all of the up-shot mode, the bust-shot mode and the full-shot mode are selected at the same time, at first the image capturing is performed in the full-shot mode to obtain a full-shot image 73 of a subject 70 in the same way as the sixth embodiment (see FIG. 16A). Then a bust-shot image 74 and an up-shot image 75 are trimmed from the full-shot image 73 with use of a trimming frame 71 for the bust-shot and a trimming frame 72 for the up-shot (see FIG. 16B and FIG. 16C). The obtained full-shot image 73, bust-shot image 74 and up-shot image 75 are stored in the memory card 17.

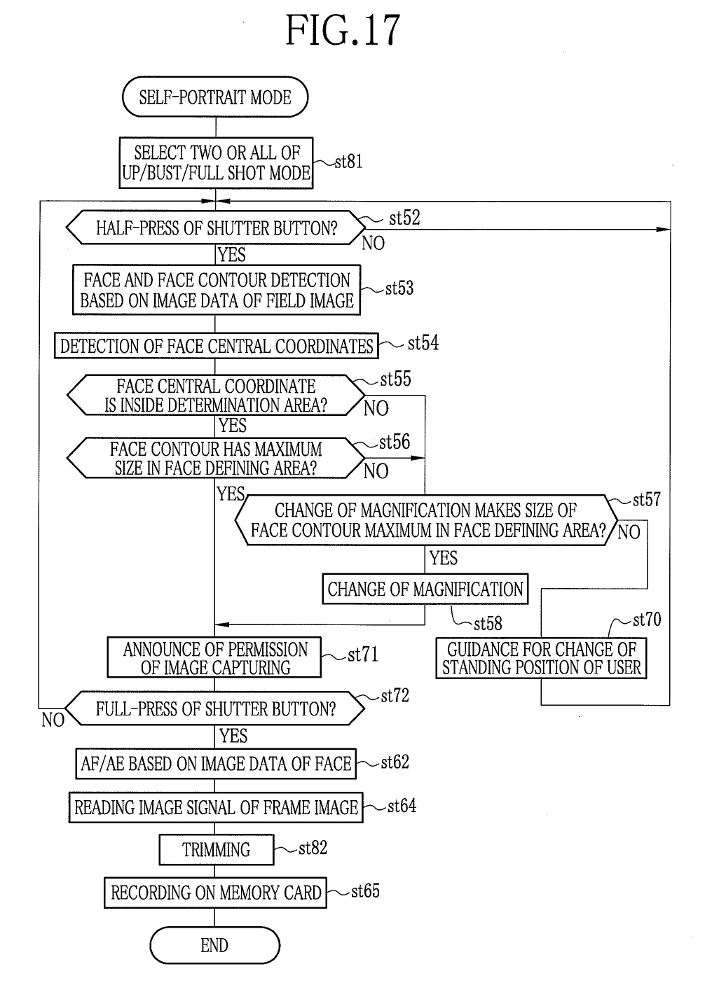

As shown in a flowchart of FIG. 17, the user selects two or three modes from the up-shot mode, the bust-shot mode and the full-shot mode in the setting screen on the LCD 22 (st81), after the self-portrait mode is set. When the up-shot mode and the bust-shot mode are selected, a bust-shot image is captured. When all modes are selected, a full-shot image is captured. Following explanations are for the case that the up-shot mode and the bust-shot mode are selected.

Image signal of a frame image is read out (st64), and then the trimming is performed to the obtained digital image data, with use of the trimming frame 66 (st82). The obtained image data of the bust-shot image 68 and the up-shot image 69 is sent to the digital signal processor 36 and subjected to the various processes. After the processes, the image data is compressed by the compression/decompression processor 37, and stored in the memory card 17 (st65).

Note that the two modes to be selected may be a combination of the bust-shot mode and the full-shot, or a combination of the up-shot mode and the full-shot mode. In these combinations, at first the image capturing is performed in the full-shot mode, and then the trimming is performed.

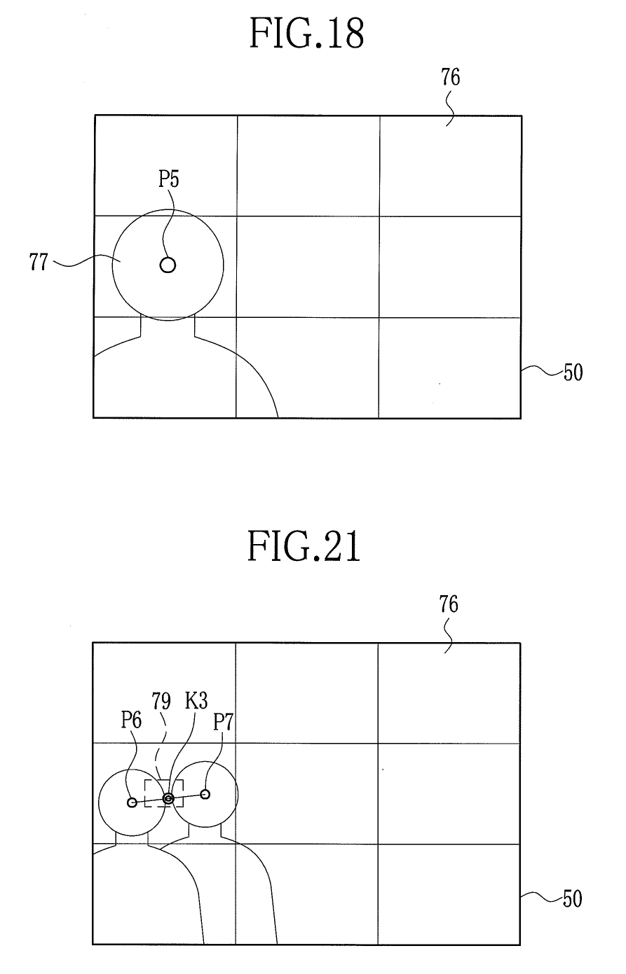

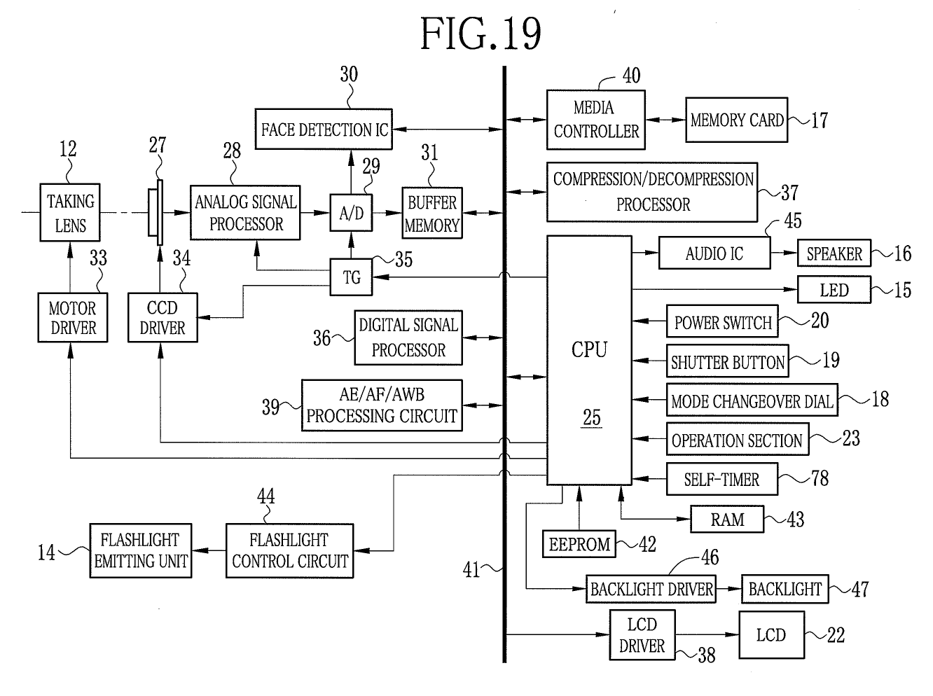

Next, the ninth embodiment of the present invention is described. The face detection IC 30 easily detects a natural face facing the front. However, it is difficult to detect a face with a hat or sunglasses, a face directed diagonally with the taking lens 12, a face with a hand nearby and so on. In consideration of the problem, as shown in FIG. 18 in this embodiment, the shooting screen 50 is virtually divided into nine segments, the user selects a segment 76 for displaying the user's face 77 from the nine segments, sets number of image capturing and a capturing interval, and actuates a self-timer 78 (see FIG. 19) to perform the self-timer capturing. At first, the user with the natural face sees straight ahead the taking lens 12 for the face detection. After the self-timer 78 measures passage of a predetermined time, image capturing of plural images is automatically performed with the set-capturing interval. While the image capturing, the user wears a hat or sunglasses, puts a hand on the face, or holds any other poses.

Note that an electronic configuration of this embodiment shown in FIG. 19 is almost same as the first embodiment. However, this embodiment is different from the first embodiment in that the self-timer 78 is provided. In this embodiment, the backlight 47 of the LCD 22 is still turned on even in the self-portrait mode. In addition, the digital camera 10 is preferably used with attached to a tripod in this embodiment.

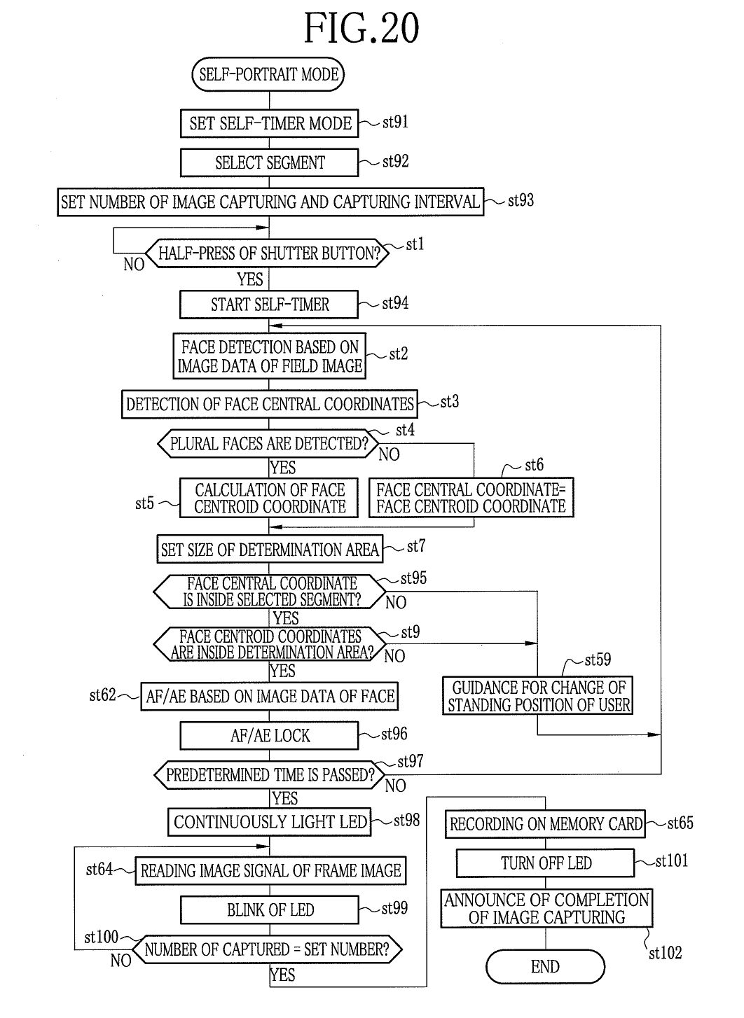

As shown in a flowchart of FIG. 20, after self-portrait mode is set, the user sets the self-timer mode in the setting screen on the LCD 22 (st91). The nine virtual segments of the shooting screen 50 are displayed on the LCD 22. Then the user touches the segment 76 for displaying the user's face 77, to select the segment 76 (st92).

In addition, the user sets number of image capturing (for example ten) and a capturing interval (for example five seconds) in the setting screen on the LCD 22 (st93). When the shutter button 19 is half-pressed (st1), the self-timer 78 is actuated (st94).

The user stands up in front of the digital camera 10, such that the natural face of the user (with no hats, sunglasses and so on) directs straight ahead the taking lens 12. The face detection IC 30 performs the face detection based on the image data of the field image (st2), and calculates the face central coordinates P5 (st3).

As shown in FIG. 21, when two faces are detected (st4), the face centroid coordinate K3 is calculated based on the face central coordinates P6 and P7 (st5). In case that there is one face (st4) as shown in FIG. 18, the central coordinates P5 becomes the face centroid coordinate (st6).

The CPU 25 determines a size of a determination area 79 according to the number of faces (st7), and judges whether all of the face central coordinates are inside the selected segment 76 or not (st95) and whether the face centroid coordinate K3 is inside the determination area 79 or not (st9).

When at least one of the judgment results is negative, the CPU 25 gives audio guidance such as “please take a step to the right”, to persuading the user to change a standing position (st59).

When both of the judgment results is positive, the AE/AF/AWB processing circuit 39 calculates a correct exposure based on the image data of the face, and determines a shutter speed, an aperture value, an imaging sensitivity, whether the flashlight emits or not, and so on according to the calculated correct exposure. The results data are input into the CPU 25.

The CPU 25 controls the CCD driver 34, the motor driver 33, the flashlight control circuit 44 and so on according to the results data (st62). In addition, the CPU 25 controls the motor driver 33 to move the focus lens of the taking lens 12 in the optical direction, such that the integration value of high frequency component obtained by the AE/AF/AWB processing circuit 39 is maximized (st62).

The CPU 25 locks the exposure conditions such as the shutter speed, the aperture value, the imaging sensitivity, and whether the flashlight emits or not, and locks the position of the focus lens (focus position) (st96). After the self-timer measures the predetermined time (st97), the CPU 25 drives the LED 15 to continuously light (st98), so that the user notices the image capturing can be performed.

The user makes a desired pose such as wearing a hat and resting the chin on the hands, without moving the position of the face 77. The image signal of the frame image is repeatedly read out with set intervals (st64), and the LED 15 blinks for example twice for every image capturing so that the user notices the image capturing is performed (st99).

The image signal of the frame image read from the CCD 27 is converted into the digital image data through the analog signal processor 28 and the A/D converter 29, and the data is stored in the buffer memory 31.

After the number of image capturing reaches the preset number (after the number of read out of image signal of frame images reaches the predetermined number) (st100), the image data stored in the buffer memory 31 is read out to the digital signal processor 36 and subjected to the various processes. After the processes, the image data is compressed by the compression/decompression processor 37, and stored in the memory card 17 (st65).

After that, the CPU 25 drives the speaker 16 to run audio guidance such as “image capturing is completed”, so that the user is noticed that the image capturing is completed (st101) Then the LED 15 is turned off (st102).

In this embodiment, one of the segments is selected. However, it is possible that plural segments are selected at the same time and each segment contains the face central coordinates of at least one face for the image capturing. In this case, when there is a segment which does not contain any face in the steps 2 and 3 of FIG. 20, the CPU 25 cautions the user to change the selection of the segments, with use of for example a display message on the LCD 22.

When the image capturing of plural persons is performed, it is preferable that a distance to each member is almost same and an amount of light toward each member is almost same, so that the focus position and the correct exposure for each face will be almost same. In addition, to obtain great depth of field, the taking lens is preferably set to the wide end.

In the fifth embodiment, whether the both eyes are open or not is judged. In addition, it is preferable that whether the eyes look the digital camera or not is judged, so that the image capturing is not performed when the eyes look away. In this case, it is preferable that when the eyes are open but a distance between the eyes becomes shorter than a predetermined value, it is judged that the eyes look away.

In the above embodiments, the CPU cautions or guides the user with use of the LED and the audio guidance. However, various sound changes or various beep sounds can be used for the same purposes. In addition, lighting patterns of the LED and sentences of the audio guidance are not limited above.

The sizes of the determination area shown in Table 1 are merely examples, and do not limit the present invention. In addition, although the shooting screen is virtually divided into the nine segments in the ninth embodiment, the number of segments is not limited (for example there may be sixteen segments).

In the above embodiments, the digital camera for capturing still images is explained. However, the present invention can be applied to a camera phone, a PDA and so on. In addition, the present invention can be applied also to a video camera and so on for capturing movies.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image capturing device for obtaining image data by photo-electrically converting a subject image focused on an imaging element through an imaging optical system, and storing said image data in a storing section, said image capturing device comprising:
a face detecting section for detecting a face of said subject based on said image data;
a face center detecting section for detecting a central coordinate of said face in a shooting screen based on said image data of said detected face;
a face centroid detecting section for detecting a centroid coordinate which is a center of all faces based on said central coordinate of each face detected by said face center detecting section when plural faces are detected by said face detecting section;
a judging section for judging whether said central coordinate of each face is inside said shooting screen or not and whether said centroid coordinate is inside a predetermined determination area provided in said shooting screen or not; and
a controlling section for permitting image capturing when said judging section judges that said central coordinate is inside said shooting screen and said centroid coordinate is inside said determination area.

2. An image capturing device claimed in claim 1 further comprising an eye detecting section for detecting both eyes of said subject based on said image data of said face detected by said face detecting section and for detecting whether said both eyes are open or not,
wherein said controlling section permits image capturing when said judging section judges that said central coordinate is inside said shooting screen and said centroid coordinate is inside said determination area, and said eye detecting section detects that said both eyes are open.

3. An image capturing device claimed in claim 1, wherein said determination area is smaller than said shooting screen which is set at the center of said shooting screen and has a shape similar to said shooting screen.

4. An image capturing device claimed in claim 1, wherein said controlling section informs said subject that said image capturing is permitted, when said controlling section permits said image capturing.

5. An image capturing device claimed in claim 1, wherein said controlling section gives a guidance to persuade the user to change a position of said subject or said image capturing device so that said image capturing is permitted, when judges that said image capturing cannot be permitted.

6. An image capturing device claimed in claim 1, further comprising an area size changing section for reducing a size of said determination area with respect to said shooting screen as the number of said detected faces increases.

7. An image capturing device claimed in claim 1, wherein said controlling section automatically performs said image capturing when permits said image capturing.

8. An image capturing device claimed in claim 7, wherein said controlling section automatically performs continuous image capturing of plural frames.

9. An image capturing device claimed in claim 1, wherein said imaging optical system is a zoom lens whose focal distance can be changed, said image capturing device further comprising:
a face size detecting section for detecting a size of said detected face in said shooting screen based on said image data of said face;
a face size designating section for designating a face size; and
a face size judging section for judging whether said detected face size corresponds with said designated face size or not,
wherein said controlling section changes said focal distance of said imaging optical system when said face size judging section judges that said detected face size does not correspond with said designated face size.

10. An image capturing device claimed in claim 9, wherein said face size designating section designates said face size according to at least one mode selected from an up-shot mode in which a closeup of said face of said subject is captured, a bust-shot mode in which an upper body of said subject is captured, and a full-shot mode in which a whole body of said subject is captured.

11. An image capturing device claimed in claim 10, wherein said controlling section performs:
capturing a bust-shot image, trimming an up-shot image from said bust-shot image and recording said bust-shot image and said up-shot image when said face size designating section designates said up-shot mode and said bust-shot mode at once;
capturing a full-shot image, trimming a bust-shot image from said full-shot image and recording said full-shot image and said bust-shot image when said face size designating section designates said bust-shot mode and said full-shot mode at once;
capturing a full-shot image, trimming an up-shot image from said full-shot image and recording said full-shot image and said up-shot image when said face size designating section designates said up-shot mode and said full-shot mode at once; and
capturing a full-shot image, trimming a bust-shot image and an up-shot image from said full-shot image and recording said full-shot image, said bust-shot image and said up-shot image when said face size designating section designates said up-shot mode, said bust-shot mode and said full-shot mode at once.

12. An image capturing device for obtaining image data by photo-electrically converting a subject image focused on an imaging element through an imaging optical system, and storing said image data in a storing section, said image capturing device comprising:
a segment designating section for virtually dividing a shooting screen into plural segments and designating a segment for displaying a face of said subject;
a number and interval setting section for setting the number of image capturing and a capturing interval;
a self-timer for starting time measurement in response to shutter release operation and permitting image capturing after a predetermined time is passed;
a face detecting section for detecting a face of said subject based on said image data after said self-timer starts time measurement;
a face center detecting section for detecting a central coordinate of said face in a shooting screen based on said image data of said detected face;
a face centroid detecting section for detecting a centroid coordinate which is a center of all faces based on said central coordinate of each face detected by said face center detecting section when plural faces are detected by said face detecting section;
a judging section for judging whether said central coordinate of each face is inside said designated segment or not and whether said centroid coordinate is inside a predetermined determination area provided in said designated segment or not;
an exposure calculating section for calculating a correct exposure based on said image data of said face;
a focus position detecting section for detecting a focus position based on said image data of said face; and
a controlling section for locking said correct exposure and said focus position and performing image capturing with said number of image capturing and said capturing interval set by said number and interval setting section, when said judging section judges that said central coordinate of each face is inside said designated segment and said centroid coordinate is inside said determination area and after said self-timer measures said predetermined time.

13. An image capturing device claimed in claim 12, wherein said controlling section gives a guidance to persuade the user to change a position of said subject or said image capturing device, when said judging section judges that said central coordinate is not inside said designated segment and/or said centroid coordinate is not inside said determination area.

14. An image capturing method for obtaining image data by photo-electrically converting a subject image focused through an imaging optical system, and storing said image data in a storing section, said image capturing method comprising steps of:
detecting a face of said subject based on said image data;
detecting a central coordinates of said face in a shooting screen based on said image data of said detected face;
detecting a centroid coordinate which is a center of all faces based on said central coordinate of each face detected by said face center detecting step when plural faces are detected by said face detecting step;
judging whether said central coordinate of each face is inside said shooting screen or not and whether said centroid coordinate is inside a predetermined determination area provided in said shooting screen or not; and
permitting image capturing when said central coordinate is judged to be inside said shooting screen and said centroid coordinate is judged to be inside said determination area.

15. An image capturing method claimed in claim 14 further comprising a step for detecting both eyes of said subject based on said image data of said face detected by said face detecting step and for detecting whether said both eyes are open or not,
wherein said image capturing is permitted when it is judged in said judging step that said central coordinate is inside said shooting screen and said centroid coordinate is inside said determination area, and said eye detecting step detects that said both eyes are open.

16. A controlling program for an image capturing device which obtains image data by photo-electrically converting a subject image focused through an imaging optical system, and stores said image data in a storing section, said controlling program controlling said image capturing device to perform processes of:
detecting a face of said subject based on said image data;
detecting a central coordinate of said face in a shooting screen based on said image data of said detected face;
detecting a centroid coordinate which is a center of all faces based on said central coordinate of each face detected by said face center coordinate detecting process when plural faces are detected by said face detecting process;
judging whether said central coordinate of each face is inside said shooting screen or not and whether said centroid coordinate is inside a predetermined determination area provided in said shooting screen or not; and
permitting image capturing when said central coordinate is judged to be inside said shooting screen and said centroid coordinate is judged to be inside said determination area.

17. A controlling program for an image capturing device claimed in claim 16 further comprising a process for detecting both eyes of said subject based on said image data of said face detected by said face detecting process and for detecting whether said both eyes are open or not,
wherein said image capturing is permitted when it is judged in said judging process that said central coordinate is inside said shooting screen and said centroid coordinate is inside said determination area, and said eyes detecting process detects that said both eyes are open.
